(19) United States
(12) Patent Application Publication
(10) Pub. No.: US 2025/0306535 A1
(43) Pub. Date: Oct. 2, 2025

(54) Protective Watch Case for Convenient Assembly

(71) Applicant: Xuying Lei, Dongguan (CN)

(72) Inventor: Xuying Lei, Dongguan (CN)

(21) Appl. No.: 18/623,053

(22) Filed: Apr. 1, 2024

(51) Int. Cl. G04B 37/00

(52) U.S. Cl. CPC G04B 37/0025

(57) ABSTRACT

A protective watch case for convenient assembly is disclosed, comprising: a case body and a cover body. The case body has slots, the sides of the case body not featuring slots are respectively equipped with a pivot mechanism and a latch mechanism. One side of the cover body is rotatably connected to the case body through the pivot mechanism, and the other side's inner surface of the cover body is equipped with a latch block that has a slot. The latch mechanism includes an elastic. When an external force acts on the latch pin, pushing it towards the interior of the case body, the end of the latch pin disengages from the slot, allowing the cover body to rotate through the pivot mechanism, thereby achieving the flip-opening of the watch case. This invention offers simple assembly and convenient operation.

### FIELD OF THE INVENTION

This invention pertains to the technical field of protective casings for watches, specifically to a protective watch case designed for convenient assembly.

### BACKGROUND OF THE INVENTION

As is well known, smartwatches are wearable time-measuring devices typically consisting of a watch core and a strap, with the core being the crucial component incorporating mechanical, electronic, or hybrid systems capable of stable operation and time measurement.

Many individuals enjoy wearing watches during physical activities, such as running or playing sports, where the watch is subjected to significant impacts and vibrations. Although the watch core is usually enclosed in a protective casing, most smartwatch casings are made from resin or silicone materials that are highly susceptible to damage from external forces, resulting in collisions and scratches to the casing and mirror surface. To address this, protective watch casings specifically for smartwatches have been developed to envelop and protect the watch core.

However, traditional protective casings typically involve complex assembly processes using screws, nuts, and other fasteners, which can be time-consuming and may compromise the watch's overall aesthetic and design, resulting in a less refined and smooth appearance. In response to this issue, the inventor has proposed the following technical solution through improvements.

### SUMMARY OF THE INVENTION

The objective of this invention is to overcome the drawbacks present in the existing technology by proposing a protective watch case for convenient assembly. This watch case not only offers comprehensive protection for the watch core but also employs a flip and plug design tailored to the watch's structure, enabling quick assembly and ease of operation for the user.

To achieve the aforementioned objective, the invention provides the following technical solution: A protective watch case for convenient assembly, comprising: a case body and a cover body. The case body has a cavity designed to house the watch core, with slots on its opposite sides for the insertion of a watch strap, these slots being in communication with the cavity. The sides of the case body not featuring slots are respectively equipped with a pivot mechanism and a latch mechanism. One side of the cover body is rotatably connected to the case body through the pivot mechanism, and its other side's inner surface features a latch block with a slot. The latch mechanism includes a latch pin that is elastically extendable beyond the case body, with the end of the latch pin equipped with a latch sleeve that engages with the slot on the latch block. When an external force acts on the latch pin, pushing it towards the interior of the case body, the end of the latch pin disengages from the slot, allowing the cover body to rotate through the pivot mechanism and achieve the flip-opening of the watch case.

Furthermore, in the aforementioned technical solution, the pivot mechanism comprises: a lower shaft sleeve set on the side wall of the case body, an upper shaft sleeve set on the side of the cover body, a pivot shaft, and a torsion spring. The lower shaft sleeve, upper shaft sleeve, and torsion spring are sleeved on the pivot shaft, allowing the cover body to rotate relative to the case body around the pivot shaft, with the torsion spring providing a torsional force to open the cover body.

Moreover, in the aforementioned technical solution, the latch mechanism includes: a latch pin passing through the side wall of the case body, a latch sleeve fixed at the inner end of the latch pin, a reset spring sleeved on the latch pin, and a pressing plate fixed at one outer end of the latch pin; the ends of the reset spring respectively abut between the outer wall of the case body and the inner wall of the pressing plate, providing an outward extending force for the latch pin.

Furthermore, in the aforementioned technical solution, the latch sleeve comprises: a limiting end and a connecting end attached to the latch pin; the slot is an open slot with an opening whose gap is larger than the diameter of the latch pin but smaller than the diameter of the connecting end, and the inner diameter of the slot is larger than that of the connecting end but smaller than that of the limiting end.

Additionally, in the aforementioned technical solution, the latch sleeve is shaped like a truncated cone, and the inner side of the slot has an inclined surface matching the latch sleeve.

Furthermore, in the aforementioned technical solution, the side of the case body where the latch mechanism is installed is provided with a knob hole and a first button hole, with a knob installed at the knob hole and a first button installed at the first button hole.

Moreover, in the aforementioned technical solution, the side of the case body where the pivot mechanism is installed is provided with a second button hole, with a second button installed at the second button hole.

Furthermore, in the aforementioned technical solution, the cover body is provided with a hollow-out for displaying the watch core.

Additionally, in the aforementioned technical solution, the bottom surface of the case body is provided with a bottom hole.

The present invention provides the following beneficial effects:

The protective watch case for convenient assembly proposed by this invention, compared to existing protective cases, features a flip-cover design. Once the cover is opened, the watch core can be placed into the cavity of the case body, and then the watch strap can be connected to the watch core through slots provided on the case body, enabling quick assembly. The entire process does not require screws or other fixed structures, avoiding damage to the watch core and strap.

The protective watch case for convenient assembly proposed by this invention, compared to existing protective cases, allows for the watch core to be placed into the case body and then, by actuating the latch pin, disengages the slot of the latch block on the cover from the latch mechanism on the case body. The cover rotates through the pivot mechanism, facilitating the flip-opening of the cover, and thus provides all-around protection for the watch core.

The protective watch case for convenient assembly proposed by this invention, compared to existing protective cases, is simple to operate. When needing to open the cover, simply apply pressure to the latch pin again, and the cover can be opened through the pivot mechanism.

The protective watch case for convenient assembly proposed by this invention, compared to existing protective cases, includes buttons. It allows for the operation of corresponding knobs and buttons on the watch core through adjustment knobs and buttons on the adjustment module, facilitating the execution of various functions of the watch.

### DESCRIPTION OF THE DRAWINGS

FIG. 1 is a perspective view of the invention;

FIG. 2 is another perspective view of the invention;

FIG. 3 is a cross-sectional view of the invention;

FIG. 4 is a perspective view of the invention with the cover opened;

FIG. 5 is an exploded view of the invention;

FIG. 6 is a perspective view of the latch mechanism of the invention;

FIG. 7 is an exploded view of the latch mechanism of the invention;

FIG. 8 is a schematic illustrating the working principle of the latch mechanism of the invention;

FIG. 9 is an exploded view of the invention with a watch during assembly;

FIG. 10 is a usage schematic of the invention after assembly with a watch.

### DETAILED DESCRIPTION OF EMBODIMENTS

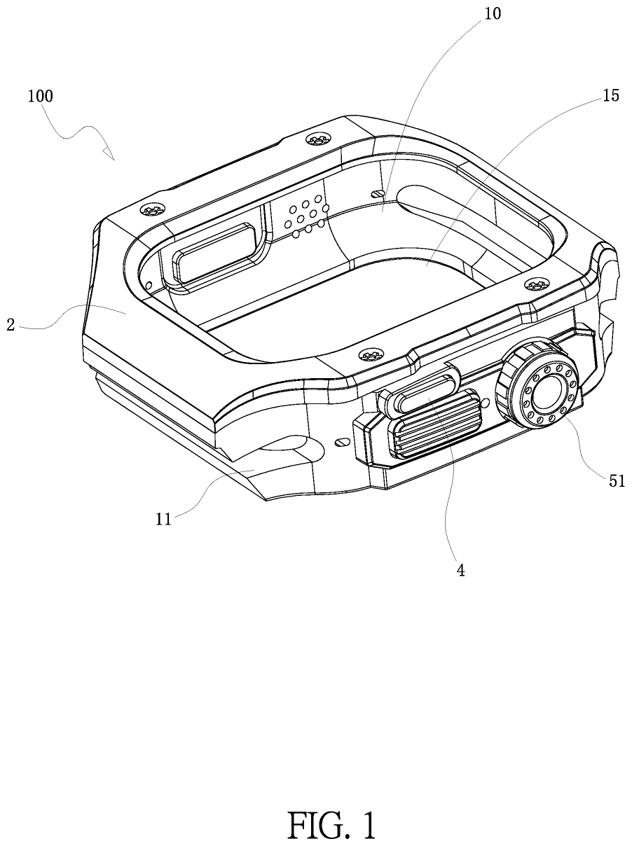

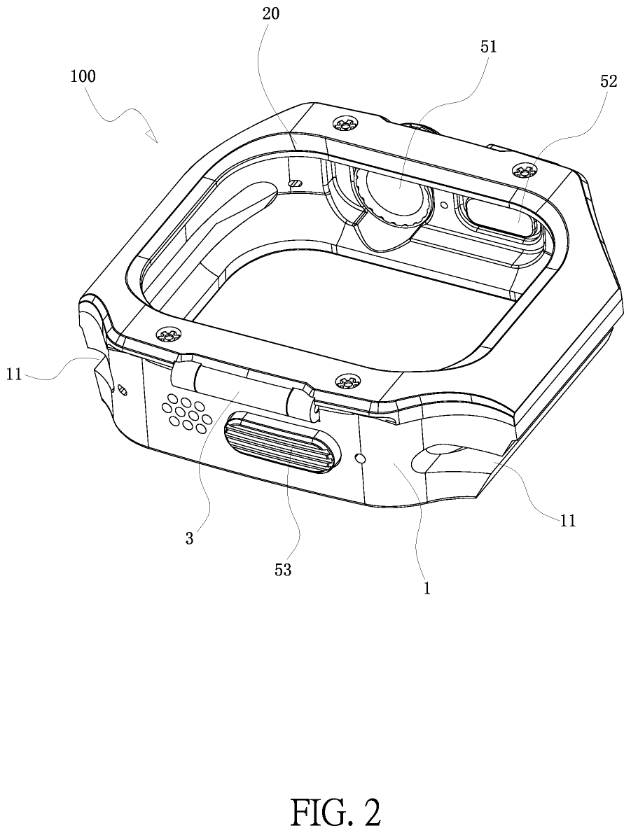

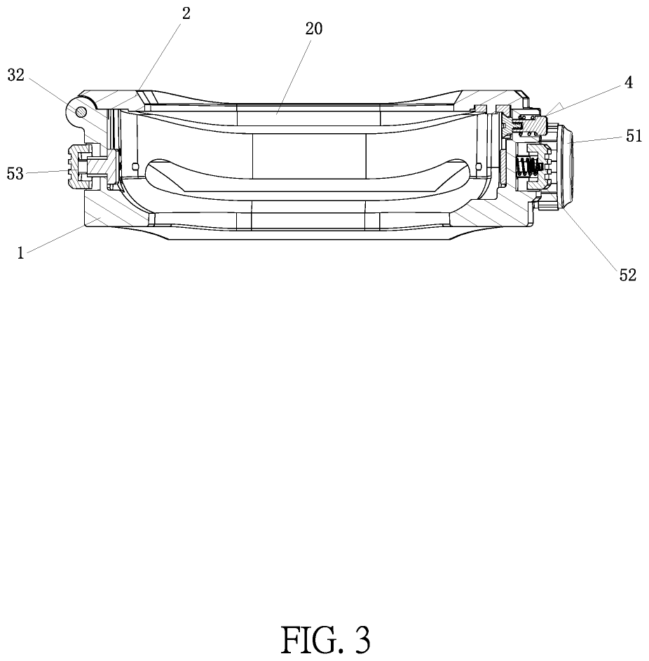

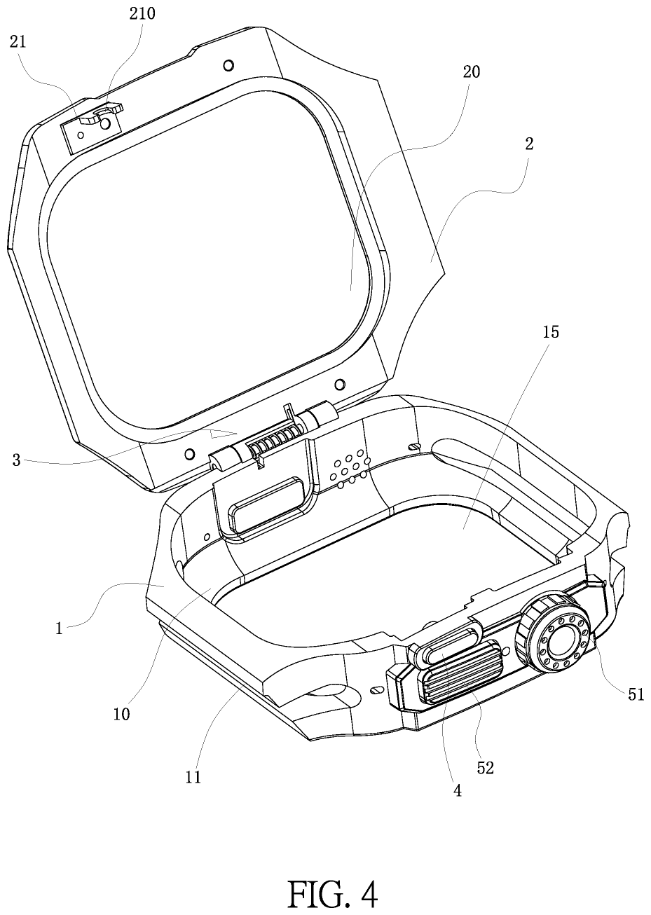

Hereinafter, the technical solutions in the embodiments of the present invention will be described clearly and completely in conjunction with the accompanying drawings. As shown in FIGS. 1 to 5, and FIGS. 8 to 10, the invention relates to a protective watch case for convenient assembly, designated as 100. This watch case includes: a case body (1), a cover body (2), a pivot mechanism (3), and a latch mechanism (4). The case body (1) has a cavity (10) designed to house a watch core (6), with the pivot mechanism (3) and the latch mechanism (4) installed on its opposite sides. One side of the cover body (2) is rotatably connected to the case body (1) through the pivot mechanism (3), allowing the cover body (2) to rotate and secure the watch core (6) placed within the cavity (10).

The cavity (10) of the case body (1) is designed to be compatible with the shape of the watch core (6) to be placed, ensuring the watch core (6) is securely positioned within the cavity (10). The sides of the case body (1) not equipped with the pivot mechanism (3) and the latch mechanism (4) respectively have slots (11) for the insertion of a watch strap (7), with these slots (11) communicating with the cavity (10). The watch strap (7) can extend through the slots (11) into the cavity (10) and connect to the strap interfaces set on the watch core (6), thus completing the assembly of the entire watch. The protective watch case (100) of the present invention solely protects the watch core (6) part and does not interfere with the normal wearing of the watch.

For some smartwatches, sensors for monitoring the human heart rate are located on the bottom surface, requiring direct contact with the skin. Therefore, the bottom surface of the case body (1) is provided with bottom holes (15), allowing the watch core (6) of the smartwatch to function normally through the bottom holes (15).

The design of the cover body (2) matches that of the case body (1), with the cover body (2) having a hollow-out (20) for displaying the watch core (6). Users can directly observe the watch's screen through the hollow-out (20) or perform corresponding touch operations. The cover body (2) not only protects the edges and corners of the watch core (6) but also prevents the watch core (6) from falling out of the cavity (10), enhancing the overall protection and safety.

One side of the cover body (2) is rotatably connected to the case body (1) through the pivot mechanism (3), and the other side's inner surface of the cover body (2) is equipped with a latch block (21) that has a slot (210).

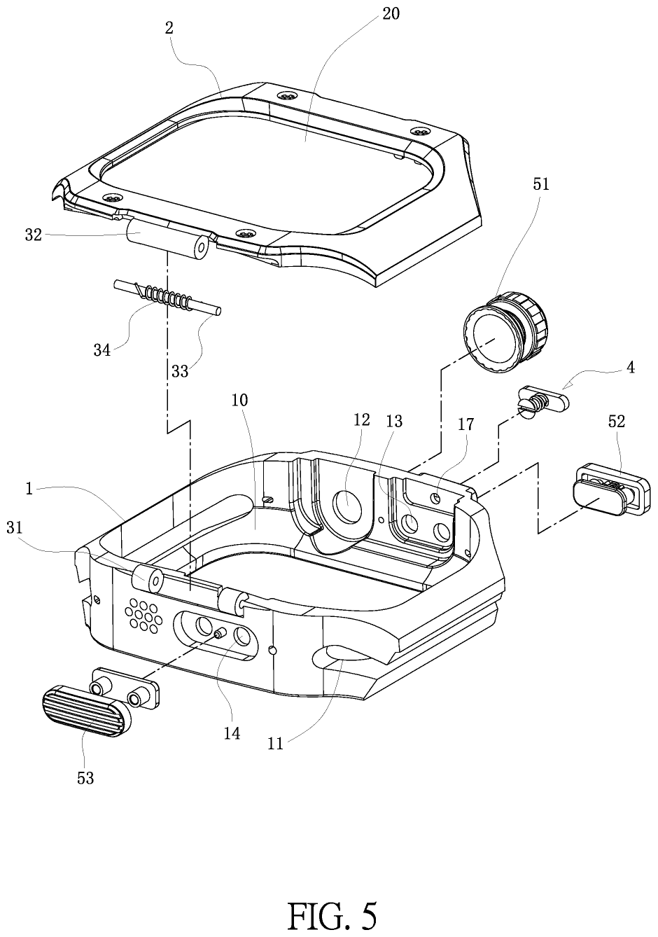

As shown in FIG. 5, the pivot mechanism (3) includes: a lower shaft sleeve (31) mounted on the side wall of the case body (1), an upper shaft sleeve (32) mounted on the side of the cover body (2), a pivot shaft (33), and a torsion spring (34), with the lower shaft sleeve (31), upper shaft sleeve (32), and torsion spring (34) sleeved on the pivot shaft (33). The lower shaft sleeve (31) and the upper shaft sleeve (32) are integrally formed on the sides of the case body (1) and the cover body (2), respectively. The cover body (2) rotates relative to the case body (1) around the pivot shaft (33), and the torsion spring (34) provides the opening torque for the cover body (2). When the cover body (2) is in a closed state, the torsion spring (34) is compressed, storing energy through its elastic deformation. Upon opening, the torsion spring (34) releases stored energy, thereby driving the cover body (2) to generate an automatic reverse torque, realizing the automatic opening of the cover body (2).

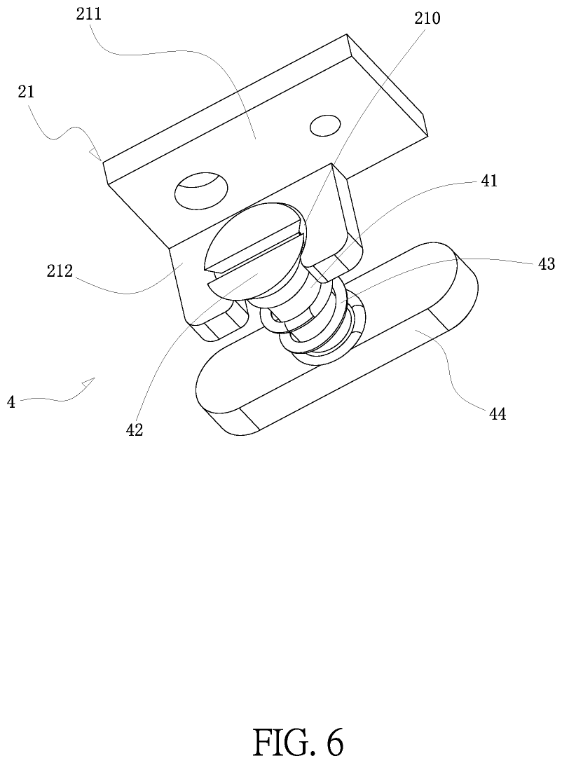

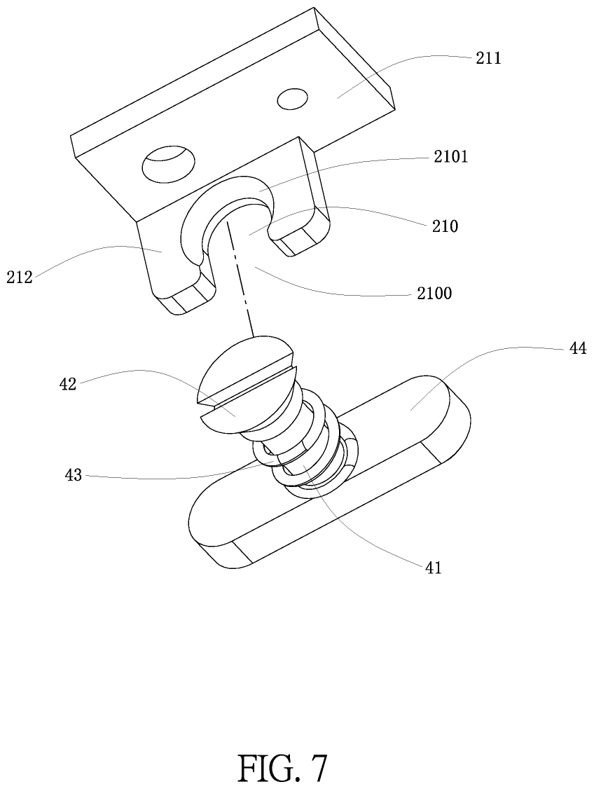

As illustrated in FIGS. 6 to 8, the latch mechanism (4) comprises: a latch pin (41), a latch sleeve (42), a reset spring (43), and a pressing plate (44). The latch pin (41) is a cylindrical segment that passes through the through-hole (17) opened in the side wall of the case body (1), with the latch sleeve (42) fixedly connected at the inner end of the latch pin (41), and the pressing plate (44) fixedly connected at the outer end of the latch pin (41). The reset spring (43) is sleeved on the latch pin (41), with its ends respectively abutting against the outer wall of the case body (1) and the inner wall of the pressing plate (44), providing an outward extending force for the latch pin (41). This means the latch pin (41), driven by the latch sleeve (42) and the pressing plate (44), tends to move outward under the force of the reset spring (43). When the user actuates the pressing plate (44), it overcomes the force of the reset spring (43) and compresses inward. Once the force acting on the pressing plate (44) is removed, the latch pin (41) along with the latch sleeve (42) and the pressing plate (44) resets.

The latch sleeve (42) includes: a limiting end (421) and a connecting end (422) that connects to the latch pin (41).

The latch mechanism (4) cooperates with the latch block (21) on the cover body (2) to complete the latch connection. Specifically, the latch block (21) is L-shaped, with a top plate (211) fixedly connected to the inner wall of the cover body (2) and a vertical plate (212) having a slot (210). The slot (210) is an incomplete circular slot with an opening (2100), where the gap of the opening (2100) is larger than the diameter of the latch pin (41) but smaller than the diameter of the connecting end (422), and the inner diameter of the slot (210) is larger than the diameter of the connecting end (422) but smaller than the diameter of the limiting end (421).

Preferably, the limiting end (421) of the latch sleeve (42) is conical in shape, and the inner side of the slot (210) has an inclined surface (2101) matching the latch sleeve (42). This configuration ensures that the conical surface of the limiting end (421) matches with the inclined surface (2101) of the slot (210), forming a more stable connection and preventing wobbling when the latch mechanism (4) engages with the slot (210) of the latch block (21).

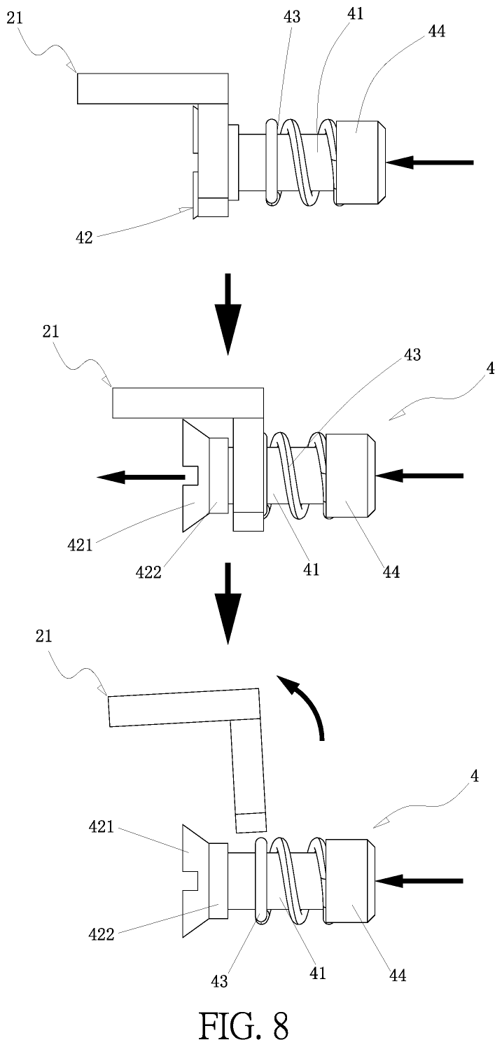

As shown in FIG. 8, the working principle of the latch mechanism (4) is as follows:

When the cover body (2) is fastened onto the case body (1), the connecting end (422) of the latch sleeve (42) falls into the slot (210). Since the gap of the opening (2100) of the slot (210) is smaller than the diameter of the connecting end (422), the latch sleeve (42) is confined within the slot (210). Simultaneously, under the action of the reset spring (43), the conical surface of the limiting end (421) of the latch sleeve (42) matches with the inclined surface (2101) of the slot (210). Since the inner diameter of the slot (210) is smaller than the diameter of the limiting end (421), the limiting end (421) ensures that they will not separate, ultimately achieving a stable coupling between the latch mechanism (4) and the slot (210).

When pressure is applied to the pressing plate (44), it overcomes the force of the reset spring (43) and compresses inward, thereby driving the latch pin (41) and the latch sleeve (42) to move inward from outside. Once they move a certain distance, the connecting end (422) of the latch sleeve (42) disengages from the slot (210), and the latch pin (41) falls into the slot (210). Since the gap of the opening (2100) of the slot (210) is larger than the diameter of the latch pin (41), the cover body (2) is no longer restricted and begins to flip open under the action of the torsion spring (34) in the pivot mechanism (3), thus opening the cover body (2).

When closing the cover body (2), the user flips the cover body (2) to close it. Under the downward pressure, the latch block (21) pushes the latch sleeve (42) inward, driving the latch pin (41) to move inward against the force of the reset spring (43). After the latch pin (41) moves inward for a certain distance, it allows the latch block (21) to move downward, causing the latch pin (41) to fall into the slot (210). Simultaneously, under the force of the reset spring (43), the conical surface of the limiting end (421) of the latch sleeve (42) fits against the inclined surface (2101) of the slot (210), re-establishing a stable coupling between the latch mechanism (4) and the slot (210), thereby achieving closure of the cover body (2).

For some watches, knobs and buttons are set on the side of the movement for adjustments. To accommodate this feature, this invention is equipped with a knob (51), a first button (52), and a second button (53). The knob (51), first button (52), and second button (53) match the knobs and buttons on the side of the watch casing, thereby enabling operation and adjustment of the watch core using this invention. Of course, these knob (51), first button (52), and second button (53) can be conFIG.d as needed.

The side of the case body (1) where the latch mechanism (4) is mounted is provided with a knob hole (12) and a first button hole (13), with a knob (51) installed at the knob hole (12), and a first button (52) installed at the first button hole (13). The side of the case body (1) where the pivot mechanism (3) is mounted is provided with a second button hole (14), with a second button (53) installed at the second button hole (14).

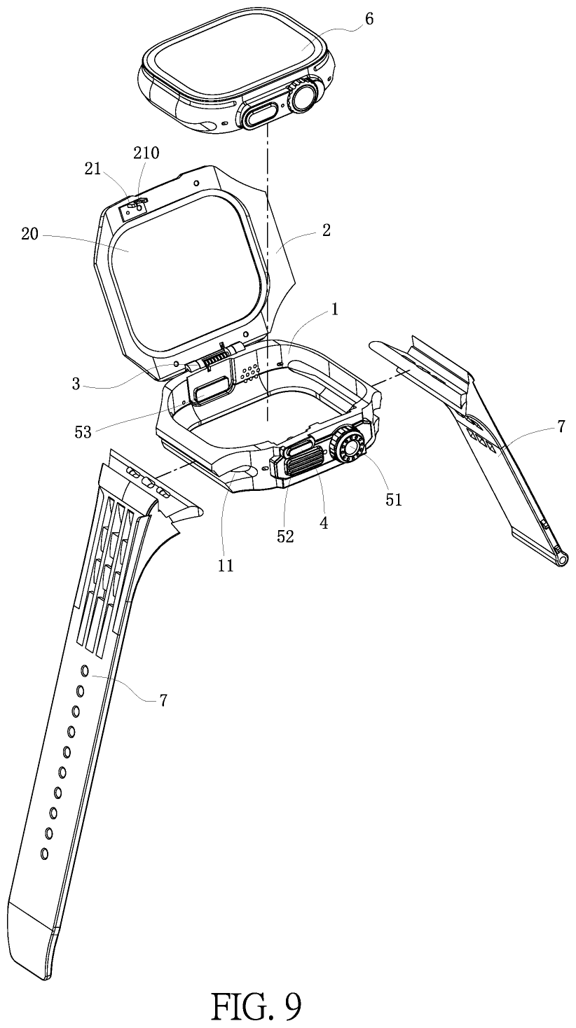

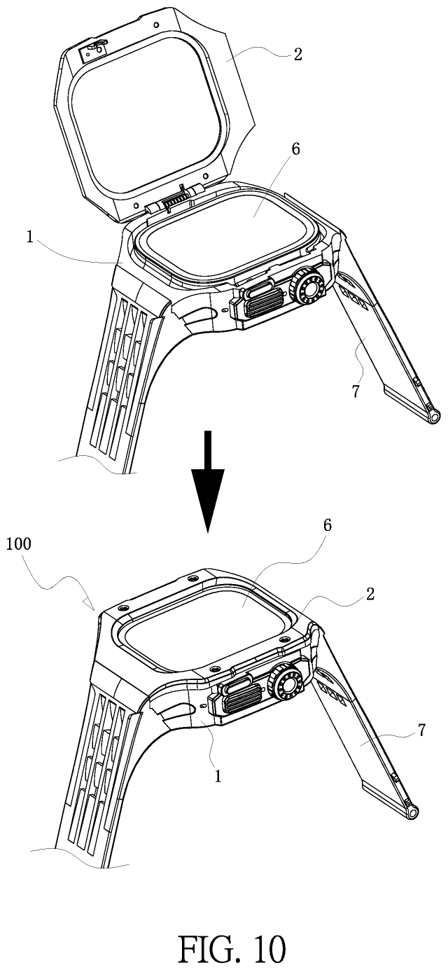

As shown in FIGS. 9 and 10, when using this utility model, first separate the watch core (6) and the watch strap (7). After opening the cover body (2), place the watch core (6) inside the cavity (10) of the case body (1), then close the cover body (2). Next, insert the watch strap (7) through the slot (11) and connect it to the interface on the watch core (6), thus completing the assembly.

To open the cover body (2), one only needs to actuate the pressing plate (44), thereby pushing the latch pin (41) towards the interior of the case body (1). This causes the latch pin (41) on the latch sleeve (42) to detach from the slot (210) on the latch block (21), allowing the cover body (2) to rotate under the drive of the torsion spring (34) in the pivot mechanism (3), flipping open the cover body (2) and thereby achieving the flip-opening of the watch case (100).

In conclusion, it should be noted that the descriptions above are merely preferred embodiments of the invention and are not intended to limit the invention. Although the invention has been described in detail with reference to the aforementioned embodiments, those skilled in the art can still modify the technical solutions recorded in the preceding embodiments or equivalently replace some of their technical features. Any modifications, equivalent replacements, improvements, etc., made within the spirit and principles of the invention should be included within the scope of the invention's protection.

I claim:

1. A protective watch case for convenient assembly, the watch case (100) comprising:
a case body (1) and a cover body (2),
wherein the case body (1) has a cavity (10) for placing a watch core (6),
the case body (1) has slots (11) for the insertion of a watch strap (7) on opposite sides of the case body, the slots (11) being in communication with the cavity (10);
the sides of the case body (1) not featuring slots (11) are respectively equipped with a pivot mechanism (3) and a latch mechanism (4); one side of the cover body (2) is rotatably connected to the case body (1) through the pivot mechanism (3), and the other side's inner surface of the cover body (2) is equipped with a latch block (21) having a slot (210);
the latch mechanism (4) includes a latch pin (41) that is elastically extendable and extends outward from the case body (1), with the end of the latch pin (41) equipped with a latch sleeve (42) that engages with the slot (210) on the latch block (21);
when an external force acts on the latch pin (41), pushing the latch pin (41) towards the interior of the case body (1), the end of the latch pin (41) disengages from the slot (210), and the cover body (2) rotates through the pivot mechanism (3), realizing the flip-opening of the watch case (100).

2. The protective watch case for convenient assembly according to claim 1, wherein the pivot mechanism (3) includes: a lower shaft sleeve (31) set on the side wall of the case body (1), an upper shaft sleeve (32) set on the side of the cover body (2), a pivot shaft (33), and a torsion spring (34), with the lower shaft sleeve (31), upper shaft sleeve (32), and torsion spring (34) sleeved on the pivot shaft (33), allowing the cover body (2) to rotate relative to the case body (1) around the pivot shaft (33), and the torsion spring (34) providing a torsional force to open the cover body (2).

3. The protective watch case for convenient assembly according to claim 1, wherein the latch mechanism (4) includes: a latch pin (41) passing through the side wall of the case body (1), a latch sleeve (42) fixed at the inner end of the latch pin (41), a reset spring (43) sleeved on the latch pin (41), and a pressing plate (44) fixed at one outer end of the latch pin (41); the reset spring (43) abuts between the outer wall of the case body (1) and the inner wall of the pressing plate (44), providing an outward extending force for the latch pin (41).

4. The protective watch case for convenient assembly according to claim 3, wherein the latch sleeve (42) includes: a limiting end (421) and a connecting end (422) that connects to the latch pin (41);
the slot (210) is an open slot with an opening (2100) whose gap is larger than the diameter of the latch pin (41) but smaller than the diameter of the connecting end (422), and the inner diameter of the slot (210) is larger than the diameter of the connecting end (422) but smaller than the diameter of the limiting end (421).

5. The protective watch case for convenient assembly according to claim 4, wherein the latch sleeve (42) is conical in shape, and the inner side of the slot (210) has an inclined surface (2101) that matches the latch sleeve (42).

6. The protective watch case for convenient assembly according to claim 1, wherein the side of the case body (1) where the latch mechanism (4) is mounted is provided with a knob hole (12) and a first button hole (13), with a knob (51) installed at the knob hole (12), and a first button (52) installed at the first button hole (13).

7. The protective watch case for convenient assembly according to claim 6, wherein the side of the case body (1) where the pivot mechanism (3) is mounted is provided with a second button hole (14), with a second button (53) installed at the second button hole (14).

8. The protective watch case for convenient assembly according to claim 1, wherein the cover body (2) is provided with a hollow-out (20) for displaying the watch core (6).

9. The protective watch case for convenient assembly according to claim 1, wherein the bottom surface of the case body (1) is provided with a bottom hole (15).
